(19) United States
(12) Patent Application Publication
(10) Pub. No.: US 2026/0018324 A1
(43) Pub. Date: Jan. 15, 2026

(54) ELECTRONIC COMPONENT

(71) Applicant: TDK Corporation, Tokyo (JP)

(72) Inventor: Eiko TAMURA, Tokyo (JP)

(73) Assignee: TDK Corporation, Tokyo (JP)

(21) Appl. No.: 18/994,647

(22) PCT Filed: May 10, 2023
(86) PCT No.: PCT/JP2023/017506

§ 371 Date: Jan. 15, 2025

(30) Foreign Application Priority Data
Aug. 10, 2022 (JP) 2022-128036

(51) Int. Cl. H01F 17/00; H01F 5/04; H01F 17/02

(52) U.S. Cl. CPC H01F 17/0006; H01F 5/04; H01F 17/02; H01F 2017/008

(57) ABSTRACT

To reduce, in an electronic component having a structure in which a plurality of inductors are provided on a substrate, the influence of coupling between the inductors. An electronic component has a circuit pattern including an inductor, a circuit pattern including an inductor, and a connection capacitor connected between the circuit patterns. The connection capacitor has capacitor electrodes, and the capacitor electrode is connected to a winding pattern constituting the inductor.

### TECHNICAL FIELD

The present disclosure relates to an electronic component and, more particularly, to an electronic component having a plurality of inductors on a substrate.

### BACKGROUND ART

Patent Document 1 discloses a surface-mounted chip-type electronic component having two inductors on a substrate.

### CITATION LIST

### Patent Document

[Patent Document 1] JP 2022-094391A

### DISCLOSURE OF THE INVENTION

### Problem to be Solved by the Invention

In electronic components of such a type, desired frequency characteristics sometimes cannot be obtained due to the influence of coupling between two inductors. To reduce the coupling between inductors, the distance therebetween may be increased; in this case, however, an increase in chip size and a reduction in inductance are disadvantageously brought about.

The present disclosure describes a technology for reducing, in an electronic component having a structure in which a plurality of inductors are provided on a substrate, the influence of coupling between the inductors.

### Means for Solving the Problem

An electronic component according to an aspect of the present disclosure includes: a substrate; a first circuit pattern including a first inductor provided on the substrate; a second circuit pattern including a second inductor provided on the substrate; and a connection capacitor connected between the first and second circuit patterns. The connection capacitor has first and second capacitor electrodes, and the first capacitor electrode is connected to a first winding pattern constituting the first inductor.

### Advantageous Effects of the Invention

According to the present disclosure, it is possible to provide a technology for reducing, in an electronic component having a structure in which a plurality of inductors are provided on a substrate, the influence of coupling between the inductors.

### BRIEF DESCRIPTION OF THE DRAWINGS

FIG. 1 is a schematic perspective view illustrating the outer appearance of an electronic component 100 according to an embodiment of the technology described herein.

FIG. 2 is a schematic cross-sectional view of the electronic component 100.

FIG. 3 is an equivalent circuit diagram of the electronic component 100.

FIG. 4 is a schematic plan view showing the pattern shapes of the conductor layers M1 and MM.

FIG. 5 is a schematic plan view showing the pattern shape of the conductor layer M2.

FIG. 6 is a schematic plan view showing the pattern shape of the conductor layer M3.

FIG. 7 is a schematic plan view showing the pattern shape of the conductor layer M4.

FIG. 8 is a schematic plan view showing the pattern shape of the conductor layer M5.

FIG. 9A is a schematic cross-sectional view illustrating constituent elements of the capacitor C2. FIG. 9B is a schematic cross-sectional view illustrating constituent elements of the connection capacitor Ck.

FIG. 10 is a graph illustrating the frequency characteristics of the electronic component 100.

FIG. 11 is a graph illustrating the frequency characteristics accordance with the capacitance of the connection capacitor Ck.

FIG. 12A to 12C are equivalent circuit diagrams of electronic components according to modifications.

### MODE FOR CARRYING OUT THE INVENTION

Hereinafter, preferred embodiments of the present invention will be described in detail with reference to the accompanying drawings.

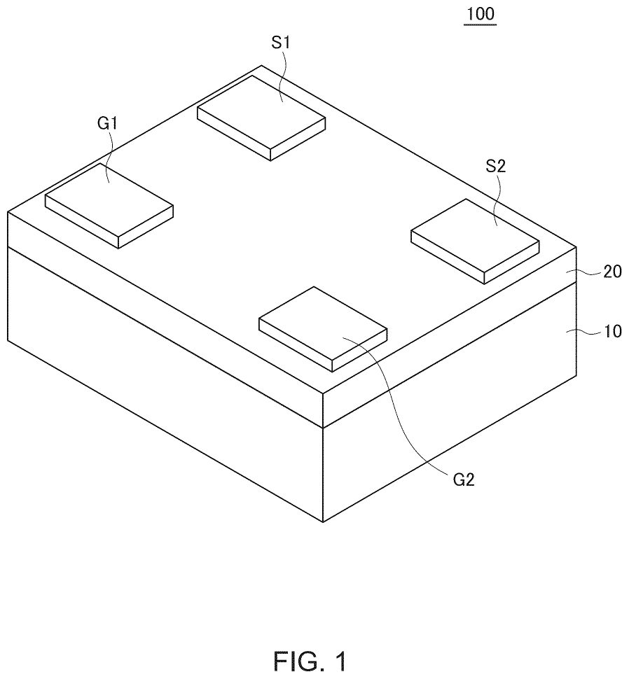

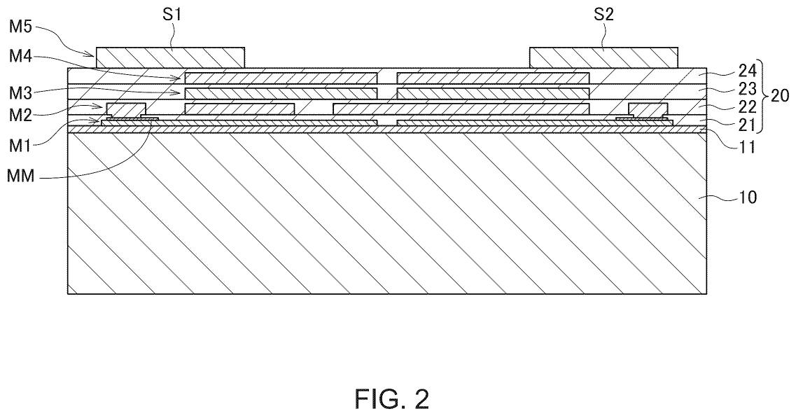

FIG. 1 is a schematic perspective view illustrating the outer appearance of an electronic component 100 according to an embodiment of the technology described herein. FIG. 2 is a schematic cross-sectional view of the electronic component 100.

The electronic component 100 according to the present embodiment is a surface-mount type high-pass filter and has, as illustrated in FIG. 1, a substrate 10, an interlayer insulating film 20 formed on the surface of the substrate 10, and signal terminals S1, S2 and ground terminals G1, G2 which are formed on the surface of the interlayer insulating film 20. As illustrated in FIG. 2, the surface of the substrate 10 is covered with a planarization layer 11, and a plurality of conductor layers M1 to M4 and MM each covered with the interlayer insulating film 20 are provided on the planarization layer 11. The signal terminals S1, S2 and ground terminals G1, G2 are formed on a conductor layer M5 positioned in the uppermost layer. The interlayer insulating film 20 includes four interlayer insulating films 21 to 24.

The material of the substrate 10 is not particularly limited as long as it is chemically and thermally stable, generates less stress, and can maintain surface smoothness, silicon single crystal, and examples thereof include alumina, sapphire, aluminum nitride, MgO single crystal, SrTiO₃ single crystal, surface-oxidized silicon, glass, quartz, and ferrite. Examples of the material of the planarization layer 11 may include alumina and silicon oxide.

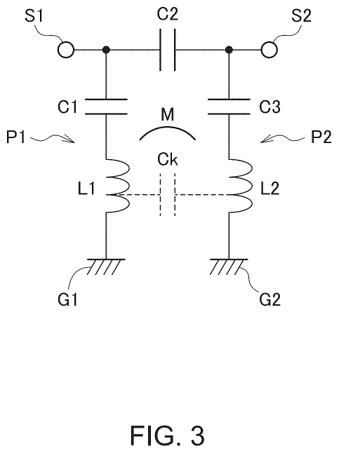

FIG. 3 is an equivalent circuit diagram of the electronic component 100 according to the present embodiment.

As illustrated in FIG. 3, the electronic component 100 according to the present embodiment has a circuit pattern P1 composed of a capacitor C1 and an inductor L1 which are connected in series between the signal terminal S1 and the ground terminal G1, a circuit pattern P2 composed of a capacitor C3 and an inductor L2 which are connected in series between the signal terminal S2 and the ground terminal G2, a capacitor C2 connected between the signal terminals S1 and S2, and a connection capacitor Ck connected between the circuit patterns P1 and P2. With this configuration, the electronic component 100 according to the present embodiment functions as a high-pass filter. The frequency characteristics of the high-pass filter are basically determined by the capacitances of the capacitors C1 to C3 and the inductances of the inductors L1 and L2; however, coupling M is generated between the inductors L1 and L2, and the frequency characteristics change in accordance with the magnitude of the coupling M. The connection capacitor Ck acts to adjust the influence that the coupling M between the inductors L1 and L2 has on the frequency characteristics.

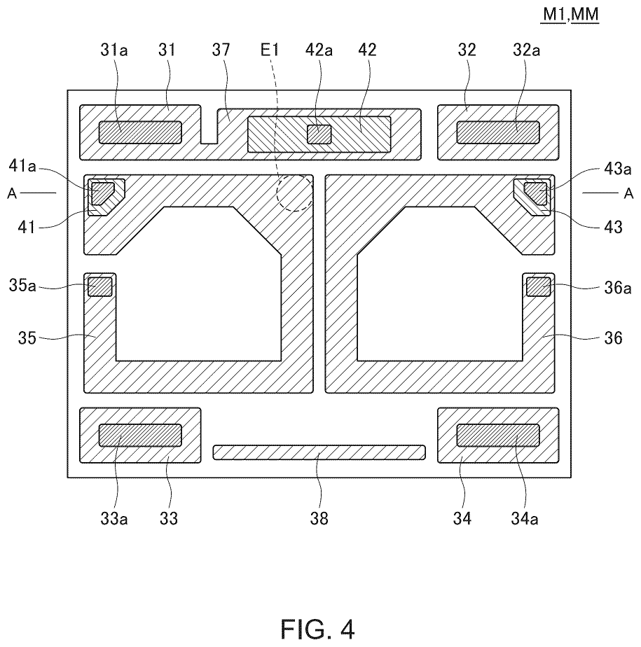

The following describes the structure of each of the conductor layers M1 to M5 and MM included in the electronic component 100. The line A-A in each of FIGS. 4 to 7 denotes the cross-sectional position in FIG. 2.

The conductor layer M1 is a conductor layer positioned in the lowermost layer and includes conductor patterns 31 to 34, winding patterns 35 and 36, a lower electrode pattern 37, and a dummy pattern 38, as illustrated in FIG. 4. The conductor patterns 31 to 34 are provided at positions overlapping respectively the signal terminals S1, S2 and ground terminals G1, G2 in a plan view. The winding patterns 35 and 36 are patterns wound in about one turn and partially constitute the inductors L1 and L2, respectively. The lower electrode pattern 37 is disposed between the conductor patterns 31 and 32 and connected to the conductor pattern 31. The dummy pattern 38 is disposed between the conductor patterns 33 and 34 and is not connected to any of the conductor patterns. The conductor patterns 31 to 34 and winding patterns 35 and 36 are connected to the upper conductor layer M2 respectively through via holes 31a to 36a formed in the interlayer insulating film 21.

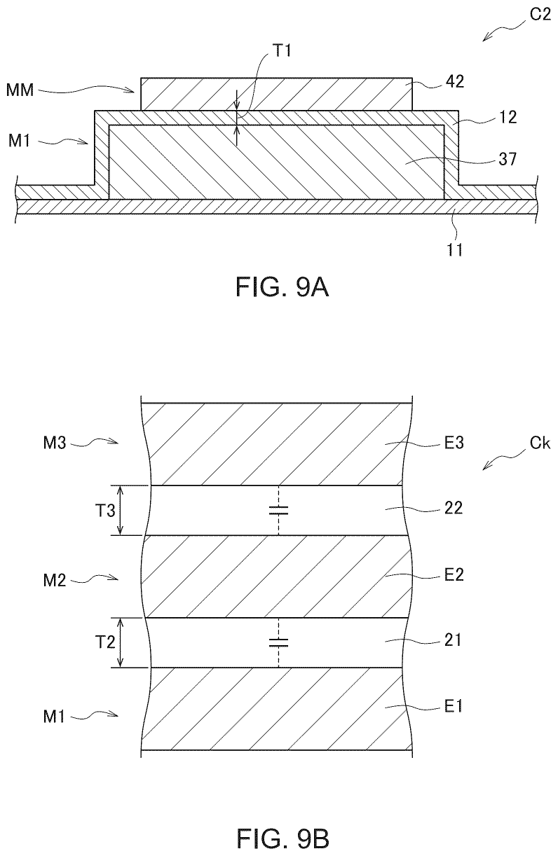

As illustrated in FIG. 9A, the surface of the conductor layer M1 is covered with a dielectric film 12, and the conductor layer MM is provided on dielectric film 12. As illustrated in FIG. 4, the conductor layer MM includes upper electrode patterns 41 to 43. The upper electrode pattern 42 is disposed at a position overlapping the lower electrode pattern 37. Thus, the lower electrode pattern 37, upper electrode pattern 42, and dielectric film 12 constitute the capacitor C2. The upper electrode patterns 41 and 43 are disposed at positions overlapping one ends of the respective winding patterns 35 and 36. A part of the winding pattern 35 that overlaps the upper electrode pattern 41 and a part of the winding pattern 36 that overlaps the upper electrode pattern 43 each function as a lower electrode. Thus, the winding pattern 35, upper electrode pattern 41, and dielectric film 12 constitute the capacitor C1, and the winding pattern 36, upper electrode pattern 43, and dielectric film 12 constitute the capacitor C3. The upper electrode patterns 41 to 43 are connected to the upper conductor layer M2 respectively through via holes 41a to 43a formed in the interlayer insulating film 21.

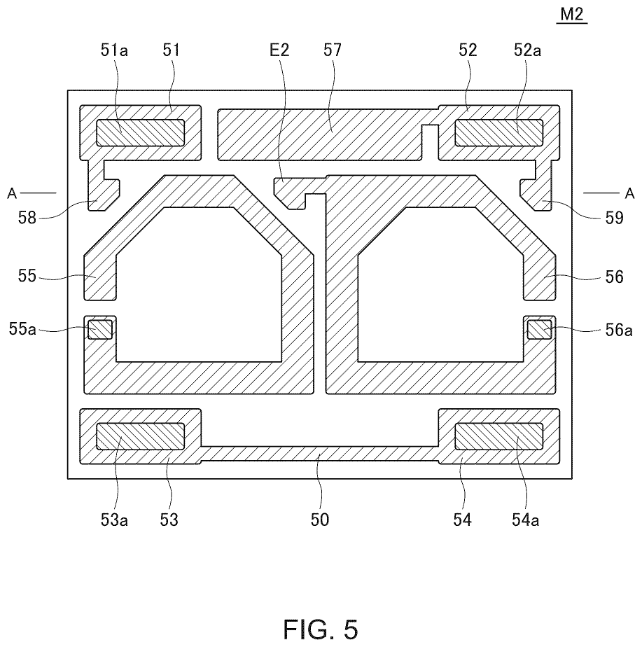

The conductor layer M2 is provided in the upper layer of the conductor layer M1 through the interlayer insulating film 21 and includes conductor patterns 50 to 54 and 57 to 59 and winding patterns 55 and 56 as illustrated in FIG. 5. The conductor patterns 51 to 54 are connected respectively to the conductor patterns 31 to 34 of the conductor layer M1 through the respective via holes 31a to 34a formed in the interlayer insulating film 21. The winding patterns 55 and 56 are patterns each wound in about one turn and partially constitute the inductors L1 and L2, respectively. One ends of the winding patterns 55 and 56 are connected respectively to the other ends of the winding patterns 35 and 36 of the conductor layer M1 through the respective via holes 35a and 36a formed in the interlayer insulating film 21. The conductor pattern 57 is disposed between the conductor patterns 51 and 52. The conductor pattern 57 is connected to the conductor pattern 52 in the same surface and further to the upper electrode pattern 42 of the conductor layer M1 through the vial hole 42a formed in the interlayer insulating film 21. The connection pattern 58 is a pattern protruding from the conductor pattern 51 toward the winding pattern 55. The connection pattern 58 is connected to the conductor pattern 51 in the same surface and further to the upper electrode pattern 41 of the conductor layer M1 through the via hole 41a formed in the interlayer insulating film 21. The connection pattern 59 is a pattern protruding from the conductor pattern 52 toward the winding pattern 56. The connection pattern 59 is connected to the conductor pattern 52 in the same surface and further to the upper electrode pattern 43 of the conductor layer M1 through the via hole 43a formed in the interlayer insulating film 21. The conductor pattern 50 is a pattern connecting the conductor patterns 53 and 54 and acts to short-circuit the ground terminals G1 and G2. There exists the dummy pattern 38 at a position overlapping the conductor pattern 50, thereby maintaining flatness. The conductor patterns 51 to 54 and winding patterns 55 and 56 are connected to the upper conductor layer M3 through respective via holes 51a to 56a formed in the interlayer insulating film 22.

The conductor layer M2 further includes a capacitor electrode E2. The capacitor electrode E2 is connected to the winding pattern 56 and protrudes from the winding pattern 56 toward the winding pattern 55. Thus, the capacitor electrode E2 overlaps a capacitor electrode E1 constituted by a part of the winding pattern 35 of the conductor layer M1 with the interlayer insulating film 20 interposed therebetween.

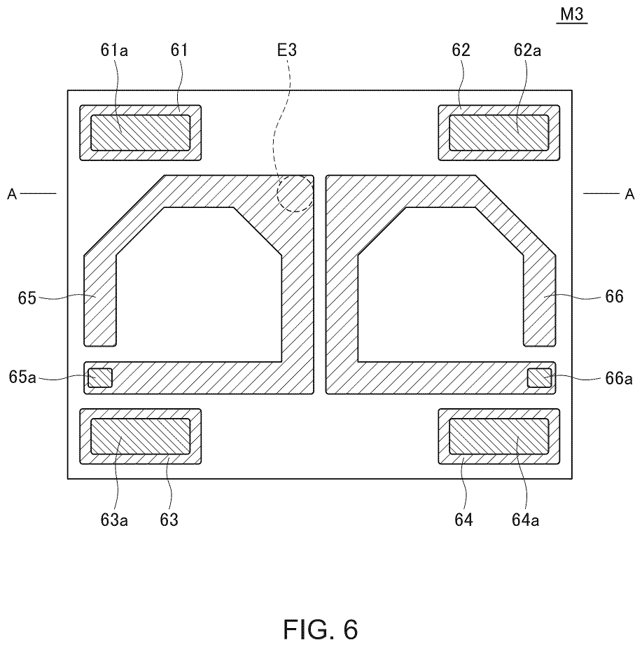

As illustrated in FIG. 6, the conductor layer M3 includes conductor patterns 61 to 64 and winding patterns 65 and 66. The conductor patterns 61 to 64 are connected respectively to the conductor patterns 51 to 54 of the conductor layer M2 through the respective via holes 51a to 54a formed in the interlayer insulating film 22. The winding patterns 65 and 66 are patterns wound in about one turn and partially constitute the inductors L1 and L2, respectively. A part of the winding pattern 65 overlaps the capacitor electrode E2 positioned in the conductor layer M2. The part overlapping with the capacitor electrode E2 constitutes a capacitor electrode E3. One ends of the winding patterns 65 and 66 are connected respectively to the other ends of the winding patterns 55 and 56 of the conductor layer M2 through the respective via holes 55a and 56a formed in the interlayer insulating film 22. The conductor patterns 61 to 64 and winding patterns 65 and 66 are connected to the upper conductor layer M4 through via holes 61a to 66a formed in the interlayer insulating film 23.

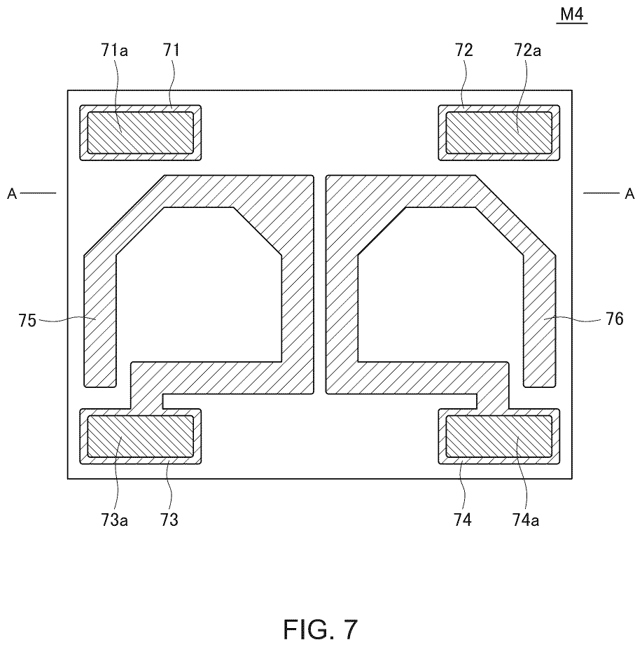

As illustrated in FIG. 7, the conductor layer M4 includes conductor patterns 71 to 74 and winding patterns 75 and 76. The conductor patterns 71 to 74 are connected respectively to the conductor patterns 61 to 64 of the conductor layer M3 through the respective via holes 61a to 64a formed in the interlayer insulating film 23. The winding patterns 75 and 76 are patterns wound in about one turn and partially constitute the inductors L1 and L2, respectively. One ends of the winding patterns 75 and 76 are connected respectively to the other ends of the winding patterns 65 and 66 of the conductor layer M3 through the respective via holes 65a and 66a formed in the interlayer insulating film 23. The other ends of the winding patterns 75 and 76 are connected respectively to the conductor patterns 73 and 74. The conductor patterns 71 to 74 are connected to the upper conductor layer M5 through via holes 71a to 74a formed in the interlayer insulating film 24.

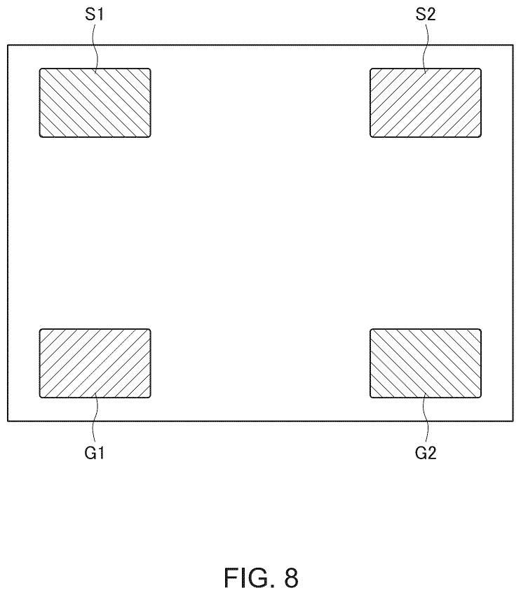

As illustrated in FIG. 8, the conductor layer M5 includes the signal terminals S1, S2 and ground terminals G1, G2. The signal terminals S1, S2 and ground terminals G1, G2 are connected respectively to the conductor patterns 71, 72, 73, and 74 of the conductor layer M4 through the respective via holes 71a, 72a, 73a, and 74a formed in the interlayer insulating film 24. The above-described conductor layers M1 to M5 and MM are made of a good conductor such as Cu (copper). The signal terminals S1, S2 and ground terminals G1, G2 may be subjected to surface treatment for enhancing soldering wettability.

With the above pattern structure, the inductor L1 is constituted by the winding patterns 35, 55, 65, and 75, and the inductor L2 is constituted by the winding patterns 36, 56, 66, and 76. The winding directions of the inductors L1 and L2 with the ground terminals G1 and G2 as starting points, respectively, are opposite to each other, whereby current flows in the same direction in the sections adjacent to the inductors L1 and L2 in the same conductor layer.

FIG. 9A is a schematic cross-sectional view illustrating constituent elements of the capacitor C2, and FIG. 9B is a schematic cross-sectional view illustrating constituent elements of the connection capacitor Ck.

As illustrated in FIG. 9A, the capacitor C2 is constituted of the lower electrode pattern 37 positioned in the conductor layer M1, the upper electrode pattern 42 positioned in the conductor layer MM, and the dielectric film 12 positioned therebetween. The dielectric film 12 is a thin film made of an inorganic insulating material such as silicon nitride (dielectric constant ε=about 6.4) and has a thickness T1 of about 1 μm, for example. The capacitance of the capacitor C2 is determined by the opposing area between the lower electrode pattern 37 and the upper electrode pattern 42 and the dielectric constant and thickness of the dielectric film 12. Although not illustrated, the capacitors C1 and C3 have the same structure.

As illustrated in FIG. 9B, the connection capacitor Ck is constituted of the capacitor electrodes E1 to E3 respectively positioned in the conductor layers M1 to M3 and the interlayer insulating films 21 and 22 positioned therebetween. The interlayer insulating film 21 is a conductor layer constituting a part of the interlayer insulating film 20 illustrated in FIGS. 1 and 2 and is positioned between the conductor layers M1 and M2. The interlayer insulating film 22 is a conductor layer constituting a part of the interlayer insulating film 20 illustrated in FIGS. 1 and 2 and is positioned between the conductor layers M2 and M3. The interlayer insulating films 21 and 22 are each a thick film made of an organic insulting material such as polyimide. Thicknesses T2 and T3 of the interlayer insulating films 21 and 22 are about several μm, for example, which is about five times larger than the thickness T1 of the dielectric film 12. The dielectric constant of polyimide is about ½ of the dielectric constant of silicon nitride. The capacitance of the connection capacitor Ck is determined by the opposing area between the capacitor electrode E2 and the capacitor electrodes E1 and E3 and the dielectric constant and thickness of the interlayer insulating films 21 and 22.

Thus, in the connection capacitor Ck, the interlayer insulating films 21 and 22 each functioning as a capacitive insulating film of the connection capacitor Ck is about ½ of the dielectric constant of the dielectric film 12, and the thicknesses T2 and T3 of the interlayer insulating films 21 and 22 are about five times larger than the thickness T1 of the dielectric film 12, so that a capacitance per unit opposing area is about 1/10 of each of the capacitors C1 to C3. Further, the opposing area in the connection capacitor Ck is smaller than that in each of the capacitors C1 to C3. As a result, the capacitance of the connection capacitor Ck is 1/10 or less of the capacitance of each of the capacitors C1 to C3.

The connection capacitor Ck is connected between the circuit patterns P1 and P2 to thereby act to reduce the influence of the coupling M between the inductors L1 and L2. A capacitance required for reducing the influence of the coupling M is minute, so that, in the present embodiment, a structure different from those of the capacitors C1 to C3 is employed the connection capacitor Ck. For example, to obtain a capacitance of 1/10 or less of that of the capacitor C1 using a similar structure to the capacitor C1, it is necessary to reduce the size of the upper electrode pattern to be formed in the conductor layer MM to 1/10 or less of the size of the upper electrode pattern 41, which may make it difficult to connect the size-reduced upper electrode pattern to the conductor layer M2 through the via hole and may increase a change in capacitance due to a variation in the size of the upper electrode pattern. On the other hand, in the present embodiment, the connection capacitor Ck is formed using the capacitor electrodes E1 to E3 facing one another through the interlayer insulating films 21 and 22, allowing even a minute capacitance to be obtained accurately. Although a capacitance is generated even in a section where the inductors L1 and L2 are adjacent to each other, the capacitance generated there is small, and a sufficient effect to reduce the influence of the coupling M cannot be expected.

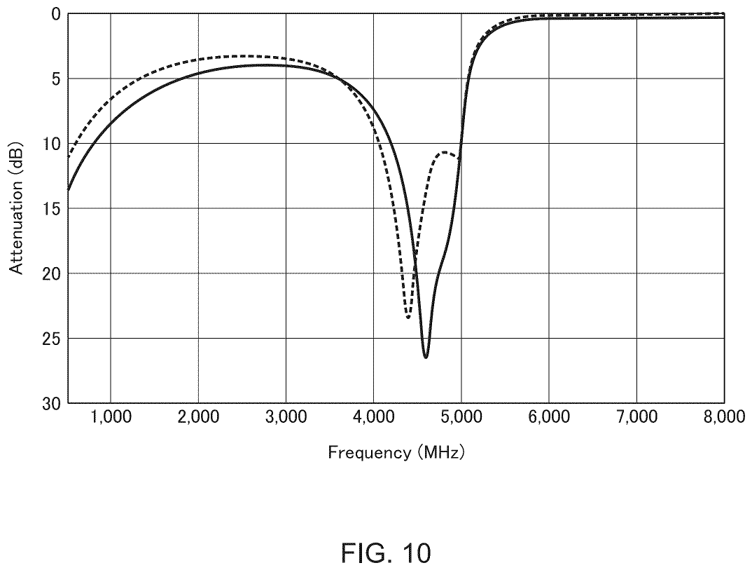

FIG. 10 is a graph illustrating the frequency characteristics of the electronic component 100 according to the present embodiment. In this graph, the solid line denotes the frequency characteristics of the electronic component 100 according to the present embodiment, and the dashed line denotes the frequency characteristics obtained when the connection capacitor Ck is omitted. The capacitance of the connection capacitor Ck is 0.02 pH.

As illustrated in the graph of FIG. 10, in the absence of the connection capacitor Ck, a small attenuation pole appears around 4.9 GHZ in addition to a main attenuation pole appearing around 4.4 GHZ, with the result that the attenuation amount around 4.6 GHZ to 4.8 GHz becomes insufficient. The reason that such two attenuation poles appear is due to the influence of the coupling M between the inductors L1 and L2. On the other hand, in the electronic component 100 having the connection capacitor Ck, a single attenuation pole appears around 4.6 GHZ, thus achieving steep attenuation characteristics. Further, the attenuation peak becomes deeper.

As described above, in the present embodiment, the inductors L1 and L2 are opposite in winding direction, whereby current flows in the same direction in the sections adjacent to the inductors L1 and L2 in the same conductor layer. This allows achievement of steeper attenuation characteristics than when the inductors L1 and L2 are the same in winding direction, whereas the attenuation pole becomes more likely to be separated into two. However, in the present embodiment, the connection capacitor Ck is used to reduce the influence of the coupling M, so that it is possible to achieve steep attenuation characteristics while preventing separation of the attenuation pole.

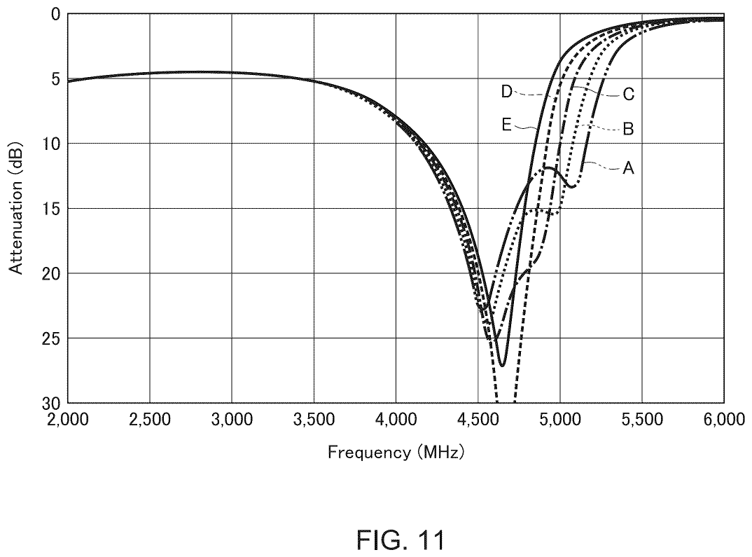

FIG. 11 is a graph illustrating the frequency characteristics of the electronic component 100 changing in accordance with the capacitance of the connection capacitor Ck. In this graph, the characteristic curve A indicates frequency characteristics obtained when the capacitance of the connection capacitor Ck is zero, the characteristic curve B indicates frequency characteristics obtained when the capacitance of the connection capacitor Ck is 0.005 pH, the characteristic curve C indicates frequency characteristics obtained when the capacitance of the connection capacitor Ck is 0.01 pH, the characteristic curve D indicates frequency characteristics obtained when the capacitance of the connection capacitor Ck is 0.015 pH, and the characteristic indicates curve E frequency characteristics obtained when the capacitance the connection capacitor Ck is 0.02 pH.

As can be seen from the graph of FIG. 11, when the capacitance of the connection capacitor Ck is 0.01 pH or less, two attenuation poles appear; on the other hand, when the capacitance of the connection capacitor Ck is 0.015 pH or more, a single attenuation pole appears. However, when the capacitance of the connection capacitor Ck is excessively large, basic frequency characteristics change significantly. As described above, in the present embodiment, when the capacitance of the connection capacitor Ck is set to 1/10 or less of the capacitance of each of the capacitors C1 to C3, adequate frequency characteristics can be achieved.

Although the connection position of the connection capacitor Ck with respect to the circuit patterns P1 and P2 is not particularly limited, at least one of the capacitor electrodes E1 to E3 may be connected to the inductor winding pattern and, thus, all the capacitor electrodes E1 to E3 may be connected to the inductor winding pattern as exemplified in the above embodiment. This can reduce the influence of the coupling M between the inductors L1 and L2 more effectively. To reduce the influence of the coupling M still more effectively, the connection position of each of the capacitor electrodes E1 to E3 may be closer to the capacitors C1 to C3. This is because portions of the connection capacitor Ck that are close to the ground terminals G1 and G2 have a low impedance to provide a small potential difference therebetween and thus reduce the effect of the connection capacitor Ck. In the present embodiment, the capacitor electrode E1 formed on the conductor layer M1 is connected to the winding pattern 35 closer to the capacitor C1 than to the ground terminal G1, and the capacitor electrode E2 formed on the conductor layer M2 is connected to the winding pattern 56 closer to the capacitor C3 than to the ground terminal G2.

As described above, the electronic component 100 according to the present embodiment uses the connection capacitor Ck to reduce the influence of the coupling M between the inductors L1 and L2 and thus can obtain adequate frequency characteristics as a high-pass filter. In addition, parts of the winding patterns 35 and 65 are used respectively as the capacitor electrodes E1 and E3, so that the winding patterns 35 and 65 increase their pattern widths, resulting in improvement in the Q-value thereof. On the other hand, the capacitor electrode E2 uses a protruding pattern protruding from the winding pattern 56, making it possible to reduce a variation in capacitance due to misalignment. Further, although the capacitor electrode E2 faces the two capacitor electrodes E1 and E3 in the present embodiment, one of the capacitor electrodes E1 and E3 may be omitted depending on a target capacitance.

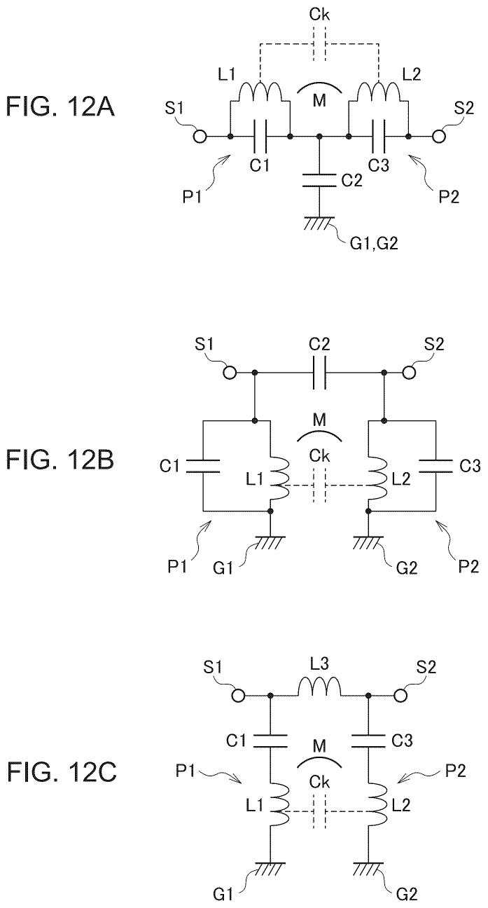

The target of the technology according to the present disclosure is not limited to a high-pass filter but may be a low-pass filter having a circuit configuration illustrated in FIG. 12A, a band-pass filter having a circuit configuration illustrated in FIG. 12B, or a low-pass filter having a circuit configuration illustrated in FIG. 12C. In the low-pass filter illustrated in FIG. 12A and in the band-pass filter illustrated in FIG. 12B, the inductor L1 and capacitor C1 which constitute the circuit pattern P1 are connected in parallel, and the inductor L2 and capacitor C3 which constitute the circuit pattern P2 are connected parallel. In the low-pass filter illustrated in FIG. 12C, an inductor L3 is used in place of the capacitor C2. Even in any of the above circuit configurations, it is possible to reduce the influence of the coupling M between the inductors L1 and L2 by connecting the connection capacitor Ck having a vary small capacitance between the circuit patterns P1 and P2.

While the preferred embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples, but not limited thereto.

An electronic component according to an aspect of the present disclosure includes: a substrate; a first circuit pattern including a first inductor provided on the substrate; a second circuit pattern including a second inductor provided on the substrate; and a connection capacitor connected between the first and second circuit patterns. The connection capacitor has first and second capacitor electrodes, and the first capacitor electrode is connected to a first winding pattern constituting the first inductor.

According to the present disclosure, it is possible to reduce the influence of coupling between the first and second inductors by means of the connection capacitor.

In the present disclosure, the second capacitor electrode may be connected to a second winding pattern constituting the second inductor. This can further reduce the influence of coupling between the first and second inductors L1 and L2.

In the present disclosure, at least a part of the first winding pattern and the first capacitor electrode may be formed on a first conductor layer formed on the substrate, at least a part of the second winding pattern and the second capacitor electrode may be formed on a second conductor layer formed on the substrate, and the first and second capacitor electrodes may face each other through a first interlayer insulating film positioned between the first and second conductor layers. Thus, the connection capacitor can be constituted by using the first and second conductor layers.

In the present disclosure, the first capacitor electrode may be constituted by a part of the first winding pattern. This improves the Q-value of the first inductor.

In the present disclosure, the second capacitor electrode may be constituted by a protruding pattern protruding from the second winding pattern. This can reduce a variation in capacitance due to misalignment.

In the present disclosure, another part of the first winding pattern may be formed on a third conductor layer provided on the substrate, the connection capacitor may further have a third capacitor electrode formed on the third conductor layer, and the second and third capacitor electrodes may face each other through a second interlayer insulating film positioned between the second and third conductor layers. Thus, the connection capacitor can be constituted by using the second and third conductor layers.

In the present disclosure, the third capacitor electrode may be constituted by a part of the first winding pattern. This improves the Q-value of the first inductor.

The electronic component according to the present disclosure may further include a first ground terminal connected to one end of the first circuit pattern and a second ground terminal connected to one end of the second circuit pattern, and the winding directions of the first and second winding patterns with the first and second ground terminals as starting points, respectively, may be opposite to each other. This can achieve steeper attenuation characteristics.

In the present disclosure, the first and second circuit patterns may further include a first capacitor and a second capacitor, respectively, and the capacitance of the connection capacitor may be smaller than the capacitances of the first and second capacitors. In this case, the capacitance of the connection capacitor may be 1/10 or less of the capacitances of the first and second capacitors. This can reduce the influence of coupling between the first and second inductors without changing basic frequency characteristics.

The electronic component according to the present disclosure may further include first and second signal terminals connected respectively to the other ends of the first and second circuit patterns, the first capacitor electrode may be connected to a part of the first winding pattern that is closer to the first capacitor than to the first ground terminal, and the second capacitor electrode may be connected to a part of the second winding pattern that is closer to the second capacitor than to the second ground terminal. This can enhance the effect of the connection capacitor.

In the present disclosure, a first dielectric constituting the connection capacitor may be made of a material whose dielectric constant is lower than that of a second dielectric constituting the first and second capacitors, and the thickness of the first dielectric may be larger than that of the second dielectric. This allows a minute capacitance to be obtained accurately.

This application claims the benefit of Japanese Patent Application No. 2022-128036, filed on Aug. 10, 2022, the entire disclosure of which is incorporated by reference herein.

### REFERENCE SIGNS LIST

10 substrate
11 planarization layer
12 dielectric film
20, 21, 22 interlayer insulating film
31-34 conductor pattern
31a-36a via hole
35, 36 winding pattern
37 lower electrode pattern
38 dummy pattern
41-43 upper electrode pattern
41a-43a via hole
50-54, 57-59 conductor pattern
51a-56a via hole
55, 56 winding pattern
61-64 conductor pattern
61a-66a via hole
65, 66 winding pattern
71-74 conductor pattern
71a-74a via hole
75, 76 winding pattern
100 electronic component
C1-C3 capacitor
Ck connection capacitor
E1-E3 capacitor electrode
G1, G2 ground terminal
L1, L2 inductor
M coupling
M1-M5, MM conductor layer
P1, P2 circuit pattern
S1, S2 signal terminal

1. An electronic component comprising:
a substrate;
a first circuit pattern including a first inductor provided on the substrate;
a second circuit pattern including a second inductor provided on the substrate; and
a connection capacitor connected between the first and second circuit patterns,
wherein the connection capacitor has first and second capacitor electrodes, and
wherein the first capacitor electrode is connected to a first winding pattern constituting the first inductor.

2. The electronic component as claimed in claim 1, wherein the second capacitor electrode is connected to a second winding pattern constituting the second inductor.

3. The electronic component as claimed in claim 2,
wherein at least a part of the first winding pattern and the first capacitor electrode are formed on a first conductor layer formed on the substrate,
wherein at least a part of the second winding pattern and the second capacitor electrode are formed on a second conductor layer formed on the substrate, and
wherein the first and second capacitor electrodes face each other through a first interlayer insulating film positioned between the first and second conductor layers.

4. The electronic component as claimed in claim 3, wherein the first capacitor electrode is constituted by a part of the first winding pattern.

5. The electronic component as claimed in claim 4, wherein the second capacitor electrode is constituted by a protruding pattern protruding from the second winding pattern.

6. The electronic component as claimed in claim 3,
wherein another part of the first winding pattern is formed on a third conductor layer provided on the substrate,
wherein the connection capacitor further has a third capacitor electrode formed on the third conductor layer, and
wherein the second and third capacitor electrodes face each other through a second interlayer insulating film positioned between the second and third conductor layers.

7. The electronic component as claimed in claim 6, wherein the third capacitor electrode is constituted by a part of the first winding pattern.

8. The electronic component as claimed in claim 2, further comprising:
a first ground terminal connected to one end of the first circuit pattern; and
a second ground terminal connected to one end of the second circuit pattern,
wherein winding directions of the first and second winding patterns with the first and second ground terminals as starting points, respectively, are opposite to each other.

9. The electronic component as claimed in claim 8,
wherein the first circuit pattern further includes a first capacitor,
wherein the second circuit pattern further includes a second capacitor, and
wherein a capacitance of the connection capacitor is smaller than capacitances of the first and second capacitors.

10. The electronic component as claimed in claim 9, wherein the capacitance of the connection capacitor is 1/10 or less of the capacitances of the first and second capacitors.

11. The electronic component as claimed in claim 9, further comprising:
a first signal terminal connected to another end of the first circuit pattern; and
a second signal terminal connected to another end of the second circuit pattern,
wherein the first capacitor electrode is connected to a part of the first winding pattern that is closer to the first capacitor than to the first ground terminal, and wherein the second capacitor electrode is connected to a part of the second winding pattern that is closer to the second capacitor than to the second ground terminal.

12. The electronic component as claimed in claim 9, wherein a first dielectric constituting the connection capacitor is made of a material whose dielectric constant is lower than a dielectric constant of a second dielectric constituting the first and second capacitors.

13. The electronic component as claimed in claim 12, wherein a thickness of the first dielectric is larger than a thickness of the second dielectric.
